(19) United States
(12) Patent Application Publication
(10) Pub. No.: US 2021/0380119 A1
(43) Pub. Date: Dec. 9, 2021

(54) METHOD AND SYSTEM FOR OPERATING A MOBILE ROBOT

(71) Applicant: STARSHIP TECHNOLOGIES OÜ, Tallinn (EE)

(72) Inventors: Kristjan KORJUS, Tallinn (EE); Mihkel KREE, Tartumaa (EE)

(21) Appl. No.: 17/283,079

(22) PCT Filed: Oct. 14, 2019
(86) PCT No.: PCT/EP2019/077772

§ 371 Date: Apr. 6, 2021

(30) Foreign Application Priority Data
Oct. 15, 2018 (EP) 18200330.1

(51) Int. Cl. B60W 50/02

(52) U.S. Cl. CPC B60W 50/0205; B60W 2050/0088; B60W 2050/0215

(57) ABSTRACT

The present invention relates to a method comprising obtaining validation sensor data from a sensor measurement at a validation observation time; generating a validation finding based on the validation sensor data; obtaining first sensor data from a sensor measurement at an observation time preceding the validation observation time; generating a first finding based on the first sensor data; and testing the first finding based on the validation finding. The present invention also relates to a corresponding method and a corresponding use.

The invention lies in the field of operating mobile robots in traffic environments. The invention also relates to mobile robots traveling on pedestrian pathways and using their sensor data to operate the robot.

Increasing mobility of goods is a characteristic of modern society. Currently, customers have a diverse set of activities, and consequently, products are required to be delivered at hours that best fit costumers' convenience. For instance, deliveries on working days out of working hours, on weekends and holidays, or even express deliveries of products are becoming more popular. Traditional means of delivery, such as couriers, are being abandoned in favor of alternatives requiring less involvement of humans, which may also provide several other advantages such as efficiency of production, energy savings and an optimized and customized delivery time, network effects, increased range of selection for customers to choose from. Moreover, mobile robots may also be helpful locally against waste and in transport.

Technology plays an important role to achieve and satisfice this consumption trend that conforms to customer preferences. In particular, robotics offers a highly convenient alternative to advance towards automation of tasks. Robotics has experienced a drastic advancement, and recently it has made possible to incorporate robots among any other traffic participants, such as pedestrians, bicyclist, and cars. Terrestrial robots are capable of accomplishing diverse specified tasks. An autonomous or semi-autonomous robot should be able to drive in many locations facing different obstacles on its way and to engage in diverse social interactions. Hence, mobile robots are equipped with several and diverse types of sensors, e.g., for navigation purposes, which allow them to locate and identify obstacles to be avoided and to reach successfully their final destination. Recently, mobile robots have been increasingly deployed in outdoor environments. Such robots can be used for maintenance (such as grass mowing or snow cleaning), security (such as surveillance or patrolling), and services (such as carrying items or delivering parcels).

For example, Starship Technologies has disclosed and launched a mobile robot configured to transport items, such as to deliver them to recipients. The applicant's international patent application WO 2017/064202 A1 discloses such mobile delivery robots.

Mobile robots traveling outdoors are generally outfitted with a plurality of sensors allowing for autonomous or semi-autonomous travel. Such sensors can allow the robots to build a computer vision picture of their surroundings, to perform navigation, mapping and localization, and to avoid colliding with other traffic participants or stationary objects. The application WO 2017/064202 A1 also discloses a large number of such sensors that can be used in a complimentary way to ensure safe and efficient operation of mobile delivery robots.

Mobile delivery robots can generally travel on pedestrian pathways but may need to cross roads to get to their destinations. To ensure maximum safety of such crossings, a reliable detection of cars approaching and/or passing on the road to be crossed is beneficial.

Some attempts to perform autonomous road crossings by sidewalk-based robots are known in the art. For instance, United States patent application US 2017/0017237 A1 discloses an autonomous moving object that calculates the optimal route of crossing the street based on detected objects and the state of the traffic light.

When relating to the operation of mobile robots, their operational safety is very desirable. That it, it is important to be able to reliably detect other traffic participants to be able to react to them and to be able to avoid accidents. Further, it is also desirable to make the robots operate efficiently, i.e., to reduce their time and energy consumption. While the prior art may be satisfactory to some extent in these regards, it is still far from optimal. That is, it is still desirable to improve the operation of mobile robots with regard to safety and efficiency.

In light of the above, it is therefore an object of the present invention to overcome or at least to alleviate the shortcomings and disadvantages of the prior art. More particularly, it is an object of the present invention to provide a method and a system to render the operation of mobile robots safe and efficient.

These objects are met by the present invention.

In a first aspect, the present invention relates to a method. The method comprises obtaining validation sensor data from a sensor measurement at a validation observation time; and generating a validation finding based on the validation sensor data.

The method may further comprise obtaining first sensor data from a sensor measurement at an observation time preceding the validation observation time; generating a first finding based on the first sensor data; and testing the first finding based on the validation finding.

As an example, a robot may approach a road and it may be intended that the robot crosses the road. The robot may then sense its environment, i.e., its surroundings with its sensors (e.g., camera) to generate “raw” first sensor data (also referred to as initial first sensor data). This “raw” first sensor data may then be transformed to first sensor data. In embodiments of the present technology, this transformation may be omitted (in other words, it may be an identity transformation leaving the data unaltered). However, in other embodiments, the “raw” first sensor data may be processed to arrive at the first sensor data. This first sensor data (e.g., based on the images) may then be used to generate a first finding, such as: “There is a car approaching”. At a time which is later than the observation time, the sensors may again sense the surroundings of the robot to generate “raw” validation sensor data (e.g., images of the car when it passes the robot). As above, this “raw” (or initial) validation sensor data may be transformed to validation sensor data, and based on this validation sensor data, a validation finding may be generated (e.g., “There is a passing car”). It will be understood that, e.g., when the car passes the robot, it will be closer to the robot and can be more easily and more reliably detected. Thus, the validation finding may generally be more reliable than the first finding. Thus, the validation finding can be used to test (e.g., validate) the first finding. Thus, the validation finding can be used to automatically determine whether the initial finding was correct.

Generally, it will be understood that before generating the validation finding (e.g., “There is a passing car”), it may be difficult to determine when to take the sensor measurements to arrive at the validation sensor data. It should thus be understood that the sensor data is usually continuously obtained, and once a validation finding is generated (e.g., “There is a passing car”), the time corresponding to the respective measurement is considered to be a validation observation time.

It will be understood that this technology allows large amounts of data relating to detection of vehicles to be annotated. Thus, the routines to arrive at the first findings may be tested (and improved), thus rendering these routines more failsafe and generally improve the operation of the robots.

The method may be performed by a data processing device.

The method may be automated.

In other words, the method may be performed without human intervention.

The method may comprise a robot driving in an environment, wherein the robot comprises a sensor unit, and the sensor unit generating initial validation sensor data and initial first sensor data, wherein the validation sensor data is based on the initial validation sensor data and the first sensor data is based on the initial first sensor data.

The sensor unit may comprise at least one camera.

The sensor unit may comprise a radar sensor, an ultrasonic sensor, and/or a time of flight sensor.

The validation finding may relate to a presence of a vehicle on a road.

The first finding may relate to a presence of a vehicle on the road.

The first finding may be a definite finding or a probabilistic finding.

A definite finding may be, e.g., “There is a car approaching” or “There is no car approaching”. A probabilistic finding may be, e.g., “The probability that there is a car approaching is 60%”. It should be understood that the definite finding can also be generated by using the probabilistic finding. More particularly, a threshold (e.g., of 50%) can be applied—probabilistic findings above this threshold may be considered to be a positive result and probabilistic findings below this threshold may be considered to be a negative result.

The first finding may relate to whether an approaching vehicle is present on the road.

When the initial validation sensor data is generated, the robot may be closer to the vehicle than when the initial first sensor data is generated.

For example, the initial first sensor data may be generated while a car is approaching the robot and the initial validation sensor data may be generated while the car passes the robot.

The initial validation sensor data may be the validation sensor data and the initial first sensor data may be the first sensor data.

That is, the initial first sensor data and the initial validation sensor data are used for the further operations without pre-processing them.

The method may further comprise processing the initial validation sensor data to generate the validation sensor data.

A quotient between the initial validation sensor data and the validation sensor data may be greater than 10, preferably greater than 1,000, further preferably greater than 100,000, such as greater than 1,000,000.

The method may further comprise processing the initial first sensor data to generate the first sensor data.

A quotient between the initial first sensor data and the first sensor data may be greater than 10, preferably greater than 1,000, further preferably greater than 100,000, such as greater than 1,000,000.

That is, instead of performing the further operations with the “raw” or initial sensor data, the subsequent analysis steps can also be performed on sensor data that has been processed. For example, when the subsequent analysis steps are performed distant from the robot (e.g., on a server), it may be advantageous to perform such steps only with processed sensor data, as in this case, a substantially reduced amount of data needs to be transferred from the robot to the distant location.

In some embodiments where the first sensor data and the validation sensor data are processed, it will be understood that the subsequent steps performed with this sensor data may be implemented at a higher level such that it does not need “raw” sensor data (e.g., raw image or radar data) to find detections or to further develop the algorithm. For example, ROS bags can be used for it and the passing cars can be found using the ROS bags for any time point even if not having saved detailed data (e.g., high-resolution images).

The step of testing the first finding based on the validation finding may be triggered when the validation finding indicates that a vehicle is present on the road.

The observation time may precede the validation observation time by 1 s to 20 s, preferably by 1 s to 10 s, such as by 1 s to 5 s.

The method may further comprise processing the initial validation sensor data and thus arriving at an estimate for the speed of the vehicle.

The estimate for the speed of the vehicle may be used to match the vehicle of the validation finding with a vehicle of the first finding.

The data processing device may be external to the robot.

The method may further comprise transmitting the first sensor data and the validation sensor data from the robot to the data processing device.

The robot may comprise the data processing device.

The method may further comprise: when the first finding differs from the validation finding, transmitting at least part of the initial first sensor data to a data processing unit external to the robot.

The method may further comprise: when the first finding differs from the validation finding, transmitting at least part of the first sensor data to a data processing unit external to the robot.

That is, in embodiments of the present invention, the data is transmitted to an external data processing unit (e.g., a server) when the first finding differs from the validation finding, i.e., in case the first finding is a false finding (i.e., a false positive or a false negative finding). It will be understood that it may be particularly interesting to further analyze such false findings to be able to reduce such false findings for future measurements.

The method may comprise generating a plurality of validation findings.

The method may comprise generating a plurality of first findings and testing each of the plurality of the first findings based on a validation finding, and thus creating a plurality of test results.

The method may further comprise utilizing the test results to determine a detection performance of the robot.

That is, in particular by generating a plurality of first findings, and validation findings (which may also be referred to as second findings), and by testing each of the plurality of first findings with a respective validation finding (i.e., second finding), for each first finding, a validity can be determined, and thus a detection performance of the subject robot can be determined.

The method may comprise a plurality of robots driving in the environment, and each of the steps may be performed for each of the robots to thus determine a detection performance for each of the robots.

The method may further comprise comparing the detection performances of the robots to detect malfunctions.

The method may further comprise generating a safety score for the road based on the plurality of test results, wherein the safety score is preferably based on the percentage of false negatives within the test results.

That is, a plurality of the above defined tests may be performed for a road, and thus a track record for the road may be generated. For instance, a road where a large percentage of the tests (i.e., comparing the validation finding with the initial finding) yield that the initial findings are incorrect may be considered to be a relatively unsafe road, while a road where the validation findings most often corresponds to the initial findings may be considered to be a relatively safe road.

The safety score may be used to determine how a robot crosses the road.

Generally, it will be understood that the robot may cross a road with different degrees of automation. The robot may cross a road (a) automatically and autonomously, i.e., the robot determines when to cross the road and then crosses the road autonomously, (b) operator-triggered and autonomously, i.e., an operator (having access to sensor data, e.g., images) may trigger the crossing that is then performed autonomously by the robot, or (c) operator-controlled, i.e., an operator controls the robot during the complete process of crossing the street. Generally, the safer a road is considered, the more autonomous and automatic a crossing may be performed be the robot.

The method may further comprise determining a traffic density based on the validation findings.

The method may further comprise generating a dashboard of results of the method.

The method may further comprise obtaining additional validation sensor data from a sensor measurement at an additional validation observation time; wherein the validation finding is generated based on the validation sensor data and on the additional validation sensor data.

The additional validation observation time may be within 2000 ms, preferably 1000 ms, further preferably 500 ms of the validation observation time. It will be understood that the additional validation observation time may be in the mentioned time range, before and after the validation observation time.

That is, in the above example, the validation sensor data may not only comprise the sensor data obtained while the vehicle is directly in front of the robot, but also sensor data “around” this time, i.e., shortly before and shortly after the vehicle is directly in front of the robot. It will be understood that this may improve the validity of the validation finding. Also, this additional validation data may also allow to more accurately estimate the speed and acceleration of a vehicle.

The step of testing the first finding based on the validation finding may be performed at least 30 s, preferably at least 1 minute, further preferably at least 10 minutes, such as at least 20 minutes, after the validation observation time.

In other words, this step does not need to be performed instantly after obtaining the sensor data. For example (in case the method is performed locally on the robot), the robot may first cross a street and then perform the analysis discussed above. This may be advantageous, as the presently described technology may thus not require computing power that is needed for the robot to cross the road.

According to further aspects, the present invention also relates to a system configured to carry out the described, and to a use of the system for carrying out the described.

That is, in general words, embodiments of the present technology relate to a method and a system for validating moving cars, which may be detected from a pedestrian pathway. More specifically, embodiments of the invention relate to detecting moving cars based on sensor data, and validating whether the detection was accurate. The invention also relates to mobile robots travelling on pedestrian pathways and using sensors to detect moving cars on traffic roads. The invention further relates to a validation detector for verifying whether cars detected from a larger distance were actually present.

The present technology may be advantageous, as it validates data and results in conclusions related to the detection of moving cars. Such validation methods can be advantageous for obtaining data that can be used to train machine learning algorithms that in turn determine the conclusions drawn by robots about the actual presence of moving cars on the road to be crossed.

That is, generally, embodiments of the present technology use data captured at two (or more) different times to validate a hypothesis based on the earlier captured data. Thus, a new method of validating car detectors on the robot is provided. Thus may allow a quantitative measure of the reliability of car detectors on the robot. It will be understood that the present technology also encompasses using different sensors to capture first data (at an earlier time) and second data used to validate first data.

Generally, in addition to validating findings, embodiments of the present technology can also be used to estimate with a very high accuracy an average traffic density of a road that the mobile robot is planning to cross. Additionally or alternatively, the present technology can also be used to detect if some sensors/detectors are not working optimally. E. g., if knowing all the passing cars, it can be calculated when did a radar, stereo or TOF started seeing something. If it almost never sees a car at a given distance but the same sensor/detector can see it in other robots then the sensor/detector might not work optimally anymore. Thus, a malfunction of a detector can be determined.

Further, results of the present technology can also be used to generate descriptive dashboards about every detector. For example, one can visualize the distribution of detected distances, speeds or probabilities by using a large up-to-date data set.

The method may also comprise determining at least one of the following features of a vehicle: speed, distance from the robot and direction of the vehicle. Thus, the type/class of the vehicle may also be determined, e.g., from neural network detections. It will be understood that these features may be determined based on the validation sensor data.

The present technology is also defined by the following numbered embodiments.

Below, method embodiments will be discussed. These embodiments are abbreviated by the letter “M” followed by a number. When reference is herein made to a method embodiment, those embodiments are meant.

M1. A method comprising
obtaining validation sensor data from a sensor measurement at a validation observation time;
generating a validation finding based on the validation sensor data.

M2. The method according to the preceding embodiment, wherein the method further comprises
obtaining first sensor data from a sensor measurement at an observation time preceding the validation observation time;
generating a first finding based on the first sensor data; and
testing the first finding based on the validation finding.

M3. The method according to any of the preceding embodiments, wherein the method is performed by a data processing device.

M4. The method according to any of the preceding embodiments, wherein the method is automated.

In other words, the method may be performed without human intervention.

M5. The method according to any of the preceding embodiments with the features of embodiment M2, wherein the method comprises
a robot driving in an environment, wherein the robot comprises a sensor unit, and wherein the method further comprises
the sensor unit generating initial validation sensor data and initial first sensor data, wherein the validation sensor data is based on the initial validation sensor data and the first sensor data is based on the initial first sensor data.

M6. The method according to the preceding embodiment, wherein the sensor unit comprises at least one camera.

M7. The method according any of the 2 preceding embodiments, wherein the sensor unit comprises a radar sensor, an ultrasonic sensor, and/or a time of flight sensor.

M8. The method according to any of the preceding embodiments, wherein the validation finding relates to a presence of a vehicle on a road.

M9. The method according to any of the preceding embodiments with the features of embodiment M2, wherein the first finding relates to a presence of a vehicle on the road.

M10. The method according to the preceding embodiment, wherein the first finding is a definite finding or a probabilistic finding.

M11. The method according to any of the 2 preceding embodiments, wherein the first finding relates to whether an approaching vehicle is present on the road.

M12. The method according to any of the preceding embodiment with the features of embodiments M5, M8, and M9, wherein
when the initial validation sensor data is generated, the robot is closer to the vehicle than when the initial first sensor data is generated.

M13. The method according to any of the preceding embodiments with the features of embodiment M5, wherein the initial validation sensor data is the validation sensor data and wherein the initial first sensor data is the first sensor data.

That is, the initial first sensor data and the initial validation sensor data are used for the further operations without pre-processing them.

M14. The method according to any of the preceding embodiments with the features of embodiment M5 and without the features of the preceding embodiment, wherein the method further comprises
processing the initial validation sensor data to generate the validation sensor data.

M15. The method according to the preceding embodiment, wherein a quotient between the initial validation sensor data and the validation sensor data is greater than 10, preferably greater than 1,000, further preferably greater than 100,000, such as greater than 1,000,000.

M16. The method according to any of the preceding embodiments without the features of embodiment M13, wherein the method further comprises
processing the initial first sensor data to generate the first sensor data.

M17. The method according to the preceding embodiment, wherein a quotient between the initial first sensor data and the first sensor data is greater than 10, preferably greater than 1,000, further preferably greater than 100,000, such as greater than 1,000,000.

M18. The method according to any of the preceding embodiments with the features of embodiments M2 and M8,
wherein the step of testing the first finding based on the validation finding is triggered when the validation finding indicates that a vehicle is present on the road.

M19. The method according to any of the preceding embodiments with the features of embodiment M2, wherein the observation time precedes the validation observation time by 1 s to 20 s, preferably by 1 s to 10 s, such as by 1 s to 5 s.

M20. The method according to any of the preceding embodiments with the features of embodiment M5 and M8, wherein the method further comprises
processing the initial validation sensor data and thus arriving at an estimate for the speed of the vehicle.

M21. The method according to the preceding embodiment and with the features of embodiment M9, wherein the estimate for the speed of the vehicle is used to match the vehicle of the validation finding with a vehicle of the first finding.

M22. The method according to any of the preceding embodiments with the features of embodiment M2, M3 and M5, wherein the data processing device is external to the robot.

M23. The method according to the preceding embodiment, wherein the method further comprises transmitting the first sensor data and the validation sensor data from the robot to the data processing device.

M24. The method according to any of the embodiments M1 to M21 with the features of M3 and M5, wherein the robot comprises the data processing device.

M25. The method according to the preceding embodiments and with the features of embodiments M2 and M5, wherein the method further comprises
when the first finding differs from the validation finding:
transmitting at least part of the initial first sensor data to a data processing unit external to the robot.

M26. The method according to any of the 2 preceding embodiments and with the features of embodiment M2, wherein the method further comprises
when the first finding differs from the validation finding:
transmitting at least part of the first sensor data to a data processing unit external to the robot.

M27. The method according to any of the preceding embodiments, wherein the method comprises generating a plurality of validation findings.

M28. The method according to the preceding embodiment and with the features of embodiment M2, wherein the method comprises generating a plurality of first findings and testing each of the plurality of the first findings based on a validation finding, and thus creating a plurality of test results.

M29. The method according to the preceding embodiment and with the features of embodiment M5, wherein the method further comprises utilizing the test results to determine a detection performance of the robot.

M30. The method according to the preceding embodiment, wherein the method comprises
a plurality of robots driving in the environment, and wherein
each of the steps is performed for each of the robots to thus determine a detection performance for each of the robots.

M31. The method according to the preceding embodiment, wherein the method further comprises comparing the detection performances of the robots to detect malfunctions.

M32. The method according to any of the preceding embodiments with the features of embodiments M8, M9, and M28, wherein the method further comprises generating a safety score for the road based on the plurality of test results, wherein the safety score is preferably based on the percentage of false negatives within the test results.

M33. The method according to the preceding embodiment, wherein the safety score is used to determine how a robot crosses the road.

MM34. The method according to any of the preceding embodiments with the features of embodiments M8 and M27, wherein the method further comprises
determining a traffic density based on the validation findings.

MM35. The method according to any of the preceding embodiments, wherein the method further comprises generating a dashboard of results of the method.

M36. The method according to any of the preceding embodiments, wherein the method further comprises
obtaining additional validation sensor data from a sensor measurement at an additional validation observation time; and
wherein the validation finding is generated based on the validation sensor data and on the additional validation sensor data.

M37. The method according to the preceding embodiment, wherein the additional validation observation time is within 2000 ms, preferably 1000 ms, further preferably 500 ms of the validation observation time.

M38. The method according to any of the preceding embodiments with the features of embodiment M2, wherein the step of testing the first finding based on the validation finding is performed at least 30 s, preferably at least 1 minute, further preferably at least 10 minutes, such as at least 20 minutes, after the validation observation time.

S1. A system configured to carry out the method according to any of the preceding embodiments.

U1. Use of the system according to the preceding embodiment for carrying out the method according to any of the preceding method embodiments.

The present invention will now be described with reference to the accompanying drawings which illustrate embodiments of the invention. These embodiments should only exemplify, but not limit, the present invention.

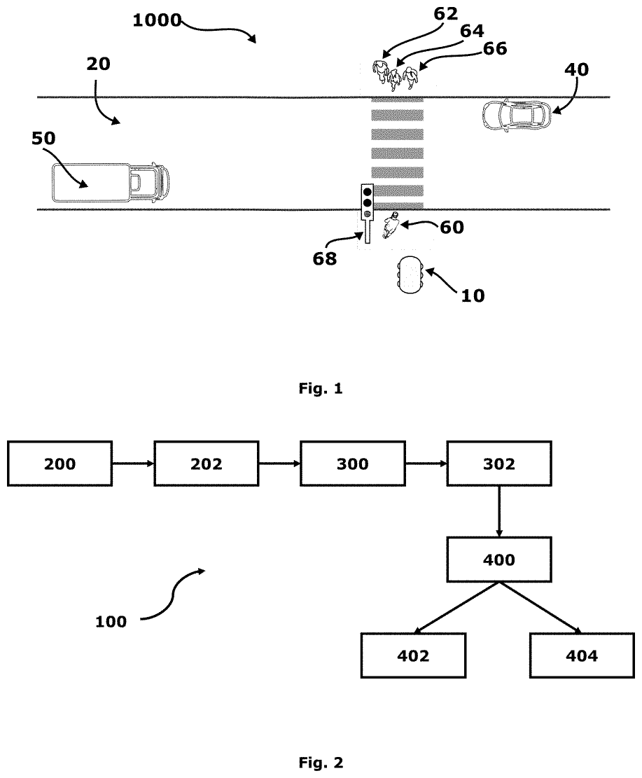

FIG. 1 depicts a scenario of a traffic environment at a pedestrian crossing;

FIG. 2 depicts schematically a system for detection of passing cars according to embodiments of the present invention;

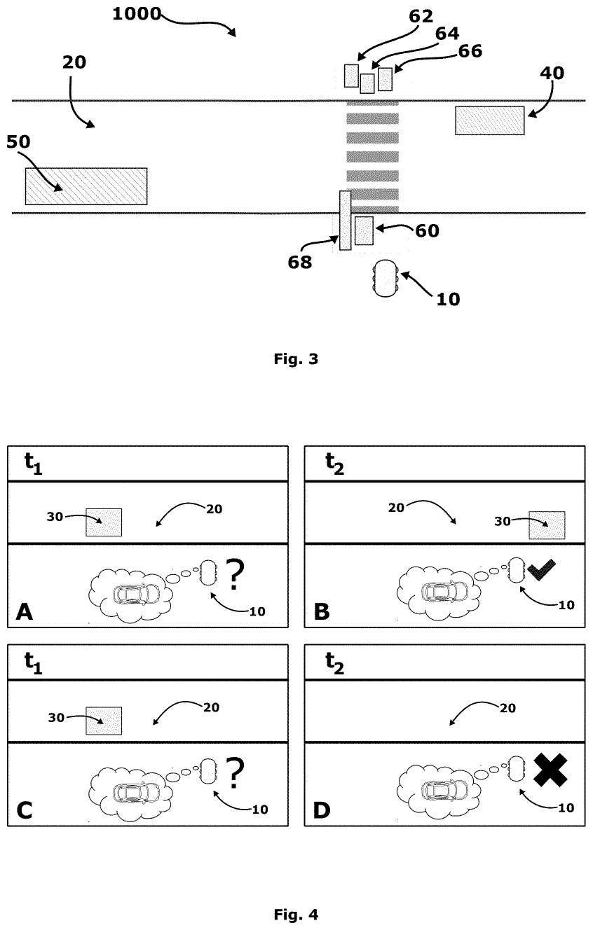

FIG. 3 depicts schematically concepts of the detection of moving objects according to embodiments of the present invention;

FIG. 4 depicts schematically concepts of a scenario of the detection of passing cars according to embodiments of the present invention;

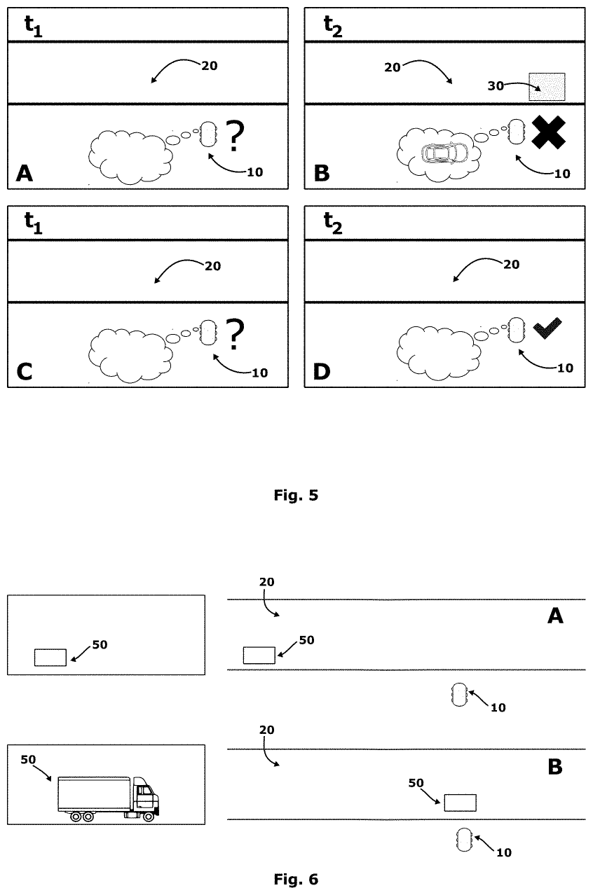

FIG. 5 depicts schematically concepts of a scenario of the detection of passing cars according to embodiments of the present invention;

FIG. 6 schematically depicts concepts of the validation of detecting cars passing in front of a mobile robot according to embodiments of the present invention;

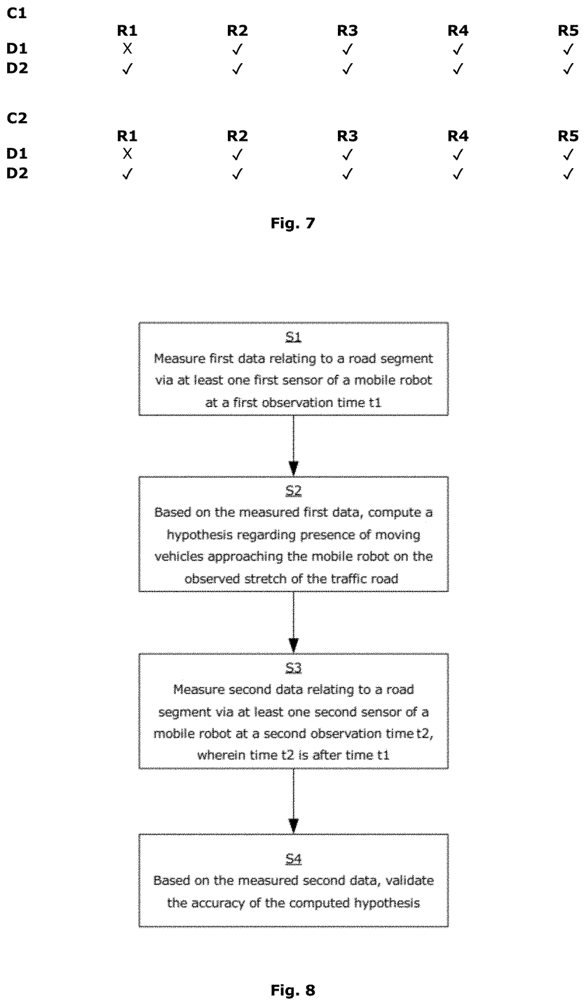

FIG. 7 depicts a table representing measurements of the validity of detections of sensor measurements;

FIG. 8 depicts a schematic representation of the passing car detector according to embodiments of the present invention.

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

Initially, general embodiments of the present technology will be described with general reference to multiple drawings, before describing the individual drawings and their components in greater detail.

As for example depicted in FIG. 1, a robot 10 may approach a road crossing and may use its sensors (cameras, radar, ToF or a combination of those) to detect any cars 40 or trucks 50 approaching towards it on a segment of the road 20 it can survey via the sensors. Depending on the sensors used, vehicles can be detected in a range of 5 m to 150 m, such as up to 100 m. Most sensors may yield satisfactory results for distances of up to 40 m. Thus, initial first sensor data may be created. In the present specification, the term initial (first, validation) sensor data and (first, validation) sensor data may be used. Generally, it should be understood that the term “first” sensor data is used to denote the “raw” sensor data initially created and that the term sensor data is used to denote sensor data that is subsequently used. In some embodiments, the initial or raw sensor data may subsequently be used, i.e., it may coincide with the sensor data. However, in other embodiments, the initial sensor data may first be processed to generate the sensor data, which is then subsequently used for further analysis. The first sensor data may be run through algorithms/detectors designed to detect faraway cars. Possibly multiple sensor data are combined at this point as well. These processes may be executed directly on the robot 10. The output can comprise a probability that there is an approaching car (or cars) from either direction. Alternatively, the output can simply comprise a binary yes/no result indicating the presence/absence of approaching cars (where as part of the algorithms/detectors, there is a certain threshold above which it is considered a detection, and below which is not). This output constitutes a hypothesis on the presence of approaching vehicles on either side of the robot, on the segment of the road accessible to the robot's sensors. Currently, one preferred combination of sensors for far-range car detection is cameras and frequency shift keying radar (FSK). A further possible sensor may also a beam formed frequency modulated continuous wave radar, such as the Ti IWR1642 by Texas Instruments.

After some time, e.g., 2 to 4 seconds later, the robot 10 may use the same or other sensors to detect whether a car has passed in front of it on the traffic road 20. The sensors employed in the present technology (both for the first detection and for the subsequent detection) may include cameras, ultrasonic sensors, radars, and/or time of flight sensors.

That is, in simple words and with exemplary reference to FIG. 4, the present technology may comprise obtaining first sensor data by a first measurement at an observation time t₁ and generating a finding based on this first sensor data (see FIG. 4A). For example, the finding may be “There is a car approaching” or “There is no car approaching”. At a later observation time t_{obs}=t₂, e.g., when the car that was approaching is passing, the present technology may obtain second sensor data, also referred to as validation sensor data, to test (i.e., validate) whether the finding based on the first sensor data has been accurate (see FIG. 4B).

In some embodiments, the present technology may also include a matching process to match an object at the observation time t_{obs}=t₂ to an object at the first observation time t₁. For example, the direction which a vehicle comes from may be used, but also other parameters such as time to passing in front of the robot based on the detection at the first observation time t₁. Generally, time, distance, speed and/or acceleration may be used for such a matching process. For example, if at the observation time t_{obs}=t₂, a car is detected to pass with a velocity of 5 m/s, then this information can be used to do some matching with previous images. The acceleration may be calculated based on the additional validation data in the close range of the validation observation time. Furthermore, not only the speed (and acceleration) at the instance of validation observation time could be used, but also used the time-evolution of the speed (and acceleration) in between the first observation time and the validation observation time may be used. That time-series data may be obtained by following an approaching object back in time from the validation observation time, which may also be referred to as tracking an (approaching) object in a traffic environment 1000 over time.

Generally, it will be understood that the following situations may occur:
A car passes in front of the robot, and it was previously detected with far-range sensors (true positive)—see FIGS. 4A and B in that regard.
A car passes in front of the robot, but it was not previously detected with far-range sensors (or detected with a certain minimum certainty threshold) (false negative)—see FIGS. 5A and B in that regard.
No car passes in front of the robot, and no car was previously detected (true negative)—see FIGS. 5C and D in that regard.
No car passes in front of the robot, but a car was previously detected (false positive)—see FIGS. 4C and D in that regard.

Out of the above four scenarios, the most critical one is false negatives, since these can lead to accidents. False positives are also undesirable, since they can lead to lower efficiency and lower average speed of the robot (since it would wait longer to cross the road out of overabundance of caution).

It will be understood that the presently described validation method uses future data to validate present data or present data to validate past data. The presently described technology is useful, e.g., for testing the quality of far-range car detectors. Further, it will also be understood that the present method can be used to automatically annotate data, which can subsequently be used, e.g., for setting detection thresholds for detectors.

Generally, it should be understood that the presently described detection and validation method may be employed both locally on the robot 10 (which may also be referred to as “live”) and external to the robot 10 (which may also be referred to as “offline”).

In the offline case, sensor data may be sent to a data processing unit external to the robot 10 (e.g., a server) and the detection algorithms may be run on the data processing unit, and the method may be performed on the server. Thus, detection algorithms can be tested using the sensor data as an input.

In the local case, i.e., when the method is employed live on the robot 10, it is possible that the detection of a passing car (see, e.g., FIGS. 4B and 5B) would trigger checking whether any detector detected the car at a previous time, e.g., 3 seconds before the detection of the passing car. If this is not the case (corresponding to the combination of FIGS. 5A and 5B), the sensor data (e.g., high resolution images) may be saved (and transmitted) for further analysis and algorithm development.

It will be understood that it is generally not necessary that the presently described technology runs instantly on the robot 10. Consider, e.g., again the case of FIGS. 5A and 5B, where the robot 10 did not detect an approaching car 30 at a first time t₁, but detected the car 30 when it passed at t₂. One further scenario (in case no further car is detected) is that the robot 10 will then cross the road 20. In this scenario, it may be beneficial that the robot 10 utilizes all of (or at least most of) its computing power for the crossing, e.g., to analyze sensor data it obtains while crossing the road. Once the robot 10 has crossed the road 20, the robot 10 may require less computing power for its further operation. Then, at least part of the presently described routine of comparing the measurements at time t₂ (when the vehicle 30 passed in front of the robot 10) with previous measurements at time t₁ can be performed. In other words, the presently described technology does not have to have only a small delay and it can use future information and it can run at times when less computing power is needed for the safe operation of the robot 10. For example, the analysis may always be done after the crossing is finished to save computational time. In such instances (e.g., after crossing), the robot 10 may still have access to the “raw” sensor data at times t₁ and t₂ (as it is not yet overwritten) and may use this raw sensor data for further analysis, and/or may send this raw sensor data, e.g., to a server for further analysis.

In other words, e.g., in order to save the raw data of the initial detection (real car detection), the passing car detections can be calculated, e.g., 30 minutes later. In embodiments of the present technology, the robot 10 may only override the raw sensor data about 1 hour after obtaining it. Thus, part of the presently described routines may be performed with a substantial delay (such as 1 minute, 5 minutes, 10 minutes, or even 30 minutes) after the raw data has been obtained. For example, this means that such steps can be performed, e.g., after the crossing has been finished.

More particularly referring to FIG. 1, there is schematically depicted a traffic environment 1000, which may comprise, for example, a mobile robot 10 operating fully or partly autonomous, which may also be referred to as autonomous and semi-autonomous mobile robot 10, respectively, or simply as mobile robot 10. In simple words, a mobile robot 10 may travel autonomously, i.e. without a user controlling its actions during active execution of tasks, or semi-autonomously, i.e. with a user only controlling the robot at some points during its operation. It will be understood that the levels of automation may differ from one embodiment to another, for example, in some instances a mobile robot 10 may operate with human assistance only for execution of some functionalities, such as, in situation where a user (e.g. a customer) receives a delivery but does not know how to proceed. In such situations, an authorized user (e.g. an operator) may remotely give instructions to the mobile robot 10 (and eventually also to the customer). Another situation where the mobile robot 10 may operate semi-autonomously is when the robot encounters unknown traffic environments 1000, such as, for example, a sidewalk partially obstructed by an object (e.g. a garbage truck parked on the sidewalk), which may result in a limited transit space (e.g. the space on the sidewalk may be exceedingly narrow for the mobile robot 10 to cross) and therefore, the situation may require the intervention of an operator.

Furthermore, the mobile robot 10 may be required to travel in a plurality of different traffic environments 1000, which may, inter alia, imply traveling on sidewalks, bike lanes and/or driveways. The mobile robot 10 may also be assigned tasks requiring, for example, crossing roads and it will also be understood that such scenarios may require execution of further steps to bring the assigned tasks to a successful completion. When a mobile robot 10 is traveling on sidewalks, the tasks may mainly be focused on the safe interaction of the mobile robot 10 with other traffic participants of sidewalks, e.g. pedestrians. However, when the mobile robot 10 is approaching a road 20, additional traffic participants have to be considered, for instance, besides pedestrians, the mobile robot 10 may encounter a plurality of driving vehicles, which may carry along a higher probability of occurrence of endangering scenarios, such as, for example, higher probability of collision of the mobile robot by and/or with a driving vehicle. The road 20 may also be referred to as traffic road(s) 20, pedestrian cross 20 road segment 20, stretch 20 or simply as segment 20. It will be understood that it may also imply other type of roads, such as, for example, crossroads.

In FIG. 1, a mobile robot 10 is positioned on a sidewalk, approaching a road conceptually identified by reference numeral 20. On the left side of the road 20 a motorized vehicle, conceptually identified by reference numeral 50, is approaching the road 20. In such a scenario, the trajectory of the mobile robot 10 and the motorized vehicle 50 may potentially converge, which may result in endangering scenarios that may compromise safety, for example, the driver of the motorized vehicle 50 may not see the mobile robot 10 and proceed with its trajectory on the road 20 and collide with the mobile robot 10. Furthermore, the mobile robot 10 may not detect the moving object 50 and continue the trajectory, which also lead to collision of the mobile robot 10 with the moving object 50. Therefore, to avoid such safety endangering incidents, the mobile robot 10 may be required to take certain safety measures, such as, for example, stopping at the road 20 and allowing the other motorized vehicles, e.g. vehicle 50, to continue their route. For this purpose, the mobile robot 10 may use a plurality of inbuilt sensors, which may be configured to measure a plurality of parameters that may allow the mobile robot 10 to analyze the scenario. Such data may be referred to as initial sensor data (which can be processed to generate sensor data), and it will be understood that the sensor data may also be used to predict future scenarios in a plurality of traffic environments 1000 exhibiting similar patterns, for instance, several motorize vehicles traveling on a given road and approaching a pedestrian crossing 20 common to the mobile robot 10. In the traffic environment 1000, the mobile robot 10 may also identify other traffic participants, for example, as depicted in FIG. 1, the mobile 10 may detect in its vicinity a pedestrian 60 just in front of the mobile robot 10. Next to the pedestrian 60, it may also be detected a traffic light 68. On the sidewalk of the road opposite to the positioning of the mobile robot 10, the mobile robot 10 may also detected three pedestrians 62, 64 and 66 approaching the pedestrian crossing 20.

In one embodiment, the mobile robot 10 may comprise at least one sensor configured to detect driving vehicles. The at least one sensor may also be referred to as detecting component 200 (see FIG. 2) and may be configured to allow the mobile robot 10 to detect other participants of the traffic environment 1000. For instance, the mobile robot 10 may detect a plurality of objects, such as for example, an object 40 and an object 50 on the road 20. Furthermore, the mobile robot 10 may identify these objects as vehicles in movement, 40 and 50, respectively. Subsequently, the mobile robot 10 may evaluate whether the vehicles 40 and 50 and their trajectory may represent an endangering factor, e.g. the mobile robot 10 may evaluate the probability of a collision with the vehicles 40 and/or 50. Hence, the mobile robot 10 may be able to collect and analyze sensor data that allow determining whether it is required to interrupt its trajectory, i.e. to stop at the road 20, and allow the other vehicles to continue their route, and retake the trajectory once the traffic environment 1000 is free of the identified moving objects 40 and/or 50.

In another scenario of the traffic environment 1000, the mobile robot may determine that the moving vehicles 40 and 50 do not represent any risk of collision, therefore the mobile robot 10 may continue its planned route. In simple words, if the mobile robot determines that the vehicle 40 and 50 are moving on the road 20, but their route will not obstruct its trajectory, e.g. the moving objects are reducing the speed and prompt to stop (at a traffic light) or the distance of the moving to the mobile robot is within safe thresholds, the mobile robot 10 may consider crossing the road without interruption, i.e. without having to wait for the moving vehicles. In some instances, such a decision may be advantageous, as it may allow optimization of the traveling of the mobile robot 10, for example, by avoiding unnecessary interruptions of the journey, which may result in an increase of average traveling speed of the mobile robot 10, i.e. it may allow to reduce traveling times between an initial point and a final destination, which subsequently permit the mobile robot 10 to efficiently perform several tasks in a reduced time. In the present invention, the mobile robot 10 may be configured to travel at different speeds according to the speed of the traffic environment 1000 and such speeds may be in the range 0 to 30 km/h, preferably 0 to 10 km/h, more preferably 0 to 6 km/h—as the robot 10 may particularly operate on a sidewalk. Therefore, it will be also understood that whenever referring to the average speed and maximizing and/or optimizing the average speed of the mobile robot 10, the speed of the mobile robot 10 does not exceed 30 km/h. It will also be understood that the speed of the mobile robot 10 is configured to be adjusted to the average speed of the traffic environment 1000, e.g. if a pedestrian is circulating in front of the mobile robot 10, the mobile robot 10 may be able to adjust its traveling speed to the speed of the pedestrian.

The mobile robot 10 may evaluate a plurality of traffic environments 1000, which may consequently lead to several possible outcomes impacting on the decision made by the mobile robot 10. For instance, the mobile robot 10 may detect one or several vehicles approaching a common road 20, thus the mobile robot 10 may be required to evaluate the situation and make a decision, e.g. stopping at the road 20 and wait until the traffic environment 1000 is cleared, i.e. until the detected vehicles have passed. Such possible scenarios are explained in detail below.

FIG. 2 schematically depicts a system 100 for the detection of passing cars. In simple term, the system 100 may comprise at least one detecting component, conceptually identified by reference numeral 200. The at least one detecting component (which may also be referred to as a sensor unit 200) may comprise a plurality of detecting elements, which may also be referred to as sensor(s) 200. The sensors 200 may be configured to perform sensor measurement to collect a plurality of initial sensor data 202, which may be processed to generate sensor data, conceptually identified by reference numeral 302. The initial sensor data 202 may comprise different type of data regarding the traffic environment 1000, for instance, the initial sensor data 202 may contain images and radar data. The initial sensor data 202 may be processed by a processing component 300 to generate sensor data 302, which may also be referred to as processed sensor data 302. The processed sensor data 302 may comprise information regarding potentially moving objects such as, for example, direction and speed of the movement of the potentially moving object, distance of the potentially object and other traffic participants (e.g. pedestrians) to mobile robot 10, estimation of the size of the potentially moving objects. The detecting component 200 may comprise a plurality of sensors 200, for example, visual sensors such as digital cameras, stereo cameras, omnidirectional cameras, light-field camera; light and detection ranging devices (LiDAR) sensors; time-of-flight (ToF) cameras; depth image capturing devices; radars such as frequency shift keying radar (FSK); and/or sonar image capturing devices such as ultrasonic sensors.

As discussed, the system 100 may also comprise a processing component, conceptually identified by reference numeral 300. The processing component 300 may be configured to retrieve information from the sensors 200, as initial sensor data 202, and may further be configured to process the sensor data 202 to generate sensor data, conceptually identified by reference numeral 302. The sensor data 302 may also be referred to as processed sensor data 302. The processed sensor data 302 may comprise information relating to velocities (such as speeds and directions) of detected objects.

The sensor data 302 may be provided to an additional processing component 400. The additional processing component 400 may generate a first finding or a first hypothesis 402 based on first sensor data and a validation finding 404 based on validation sensor data, wherein the first sensor data is based on a measurement preceding the measurement forming the basis for the validation sensor data. These findings 402, 404 may be compared with one another to thus test the first finding and to determine the validity of the first finding 402.

The findings 402, 404 may contain analyzed information regarding the traffic environment 1000. For instance, the first finding may contain information such as a list of identified objects, which may comprise potentially moving objects as well as potentially static objects, which may be of interest for the mobile robot 10 to execute further tasks such as stopping at a given point, rerouting its trajectories, etc. Further, examples of identified objects as potentially moving objects may comprise vehicles moving away from and/or towards the mobile robot 10 such as cars, buses, tracks, bicycles (representing first findings 402). Moreover, a potentially moving object may also represent a person walking away from and/or towards the mobile robot 10. Examples of identified objects as potentially static objects may comprise parked vehicles such as cars, buses, trucks, bicycles. Moreover, a potentially static object may also represent a traffic light at a pedestrian crossing 20, and for example a person standing at the traffic light and waiting for traffic light clearance to cross the road, etc.

That is, in one embodiment, the additional processing component 400 may also be configured to generate a plurality of first findings or hypotheses regarding the identified objects and may also further analyze a plurality of possible outcoming scenarios. For instance, the processing component may be configured to determine whether a detected object may in fact be a moving object and whether the moving object may be moving towards the mobile robot 10.

In another embodiment, the additional processing component 400 may further be configured to evaluate the possible consequence of a plurality of scenarios. For instance, the additional processing component 400 may be able to infer whether a given scenario may result in safety endangering event, such as, for example, a collision of the mobile robot 10 with a moving object.

It will be understood that the additional processing component 400 may comprise a plurality of algorithms configured to execute the detection of objects in a traffic environment 1000.

The additional processing component 400 may be realized as a server 400 external from and remote from the robot 10. It will be understood that the server 400 may comprise at least one server 400 and therefore may also be referred to as servers 400. It will also be understood that the server 400 may also comprise a remote server and/or a cloud server.

In some embodiments, the mobile robot 10 may collect initial sensor data 202 via a detecting component 200, may process the initial sensor data 202 by a processing components 300 (which may be part of the robot 10) to generate (processed) sensor data 302 and subsequently may send this sensor data 302 to the server 400 for further processing. Therefore, it will be understood that in some embodiments, the processing component 300 inbuilt in the mobile robot 10 may, for example, perform a pre-processing of the initial sensor data 202 and provide the information to a server 400 as processed sensor data 302. It will also be understood that the processed data 302 may be subjected to further analysis in the server 400. For this purpose, the server 400 may be bidirectionally connected to the processing component 300 and this bidirectional connection may be advantageous, as it may allow the mobile robot 10 to retrieve information from the processing component 300 and implement them to bring its assigned tasks to successful completion. Furthermore, further analyzing the processed sensor data 302 in a server 400 may also be advantageous in some instances, as the server 400 may comprise further and more advanced processes such as, for example, additional algorithms, pattern recognitions, machine learning, advance artificial intelligence, etc. Moreover, the server 400 may also comprise further storing modules configured to generate a data base, i.e. enough storing capacity to generate historical data and parameters. The historical data may, for instance, comprise historical records of events of a plurality of traffic environments 1000 (e.g. crossroad, road segments, sidewalks, etc.), e.g., hypotheses that were computed and their corresponding outcomes (e.g. a false negative, true positive, etc.). In some instances, the historical records of events may also include further information such as safety records, number of safety endangering scenarios (e.g. numbers of accidents such as collisions).

In some instances, a computer vision may be advantageous, as it may facilitate the mobile robot 10 to understand the traffic environment 1000 in order to implement information for execution of further tasks, e.g. automated decision-making processes such as stopping at a road to allow a moving vehicle to continue its route.

In simple words, the system 100 may comprise a detection component 200 configured to collect initial sensor data 202, which may be subsequently provided to a processing component 300 to generate sensor data 302, that may also be referred to as processed sensor data 302. The processed sensor data 302 may contain a plurality of parameter and data that may allow the mobile robot 10 to correctly execute assigned tasks in a traffic environment 1000.

That is, in summary, the system 100 depicted in FIG. 2 may comprise a detection component 200 (that may also be referred to as a sensor unit), as well as processing components 300 and 400.

The detection component 200 may sense the surroundings of the robot 10, e.g., it may comprise cameras and/or radar sensors. Thus, initial sensor data 202 (e.g., images or radar data) may be created. The initial sensor data 202 may be processed by processing component 300 to generate processed sensor data 302. The processed sensor data 302 may comprise information relating to objects that were detected, e.g., it may comprise information relating to a size of an object, its speed, its direction of movement and its distance to the robot. The processed sensor data 302 may be provided to an additional processing component 400 that may generate findings 402 and 404 by utilizing the sensor data 302.

More particularly, the additional processing component 400 may generate a first finding 402 based on first sensor data and a validation finding 404 based on validation sensor data. The validation sensor data may be based on measurements taking place after the measurements on which the first sensor data is based. For example, the validation sensor data (and thus the validation finding 404) may be based on a measurement of a car that just passed in front of the robot 10, while the first sensor data (and thus the first finding 402) is based on a previous measurement of the car, i.e., on a measurement of the car while it was approaching. It will be understood that the validation finding (based on the car passing in front of the robot 10) may typically be more accurate than the first finding (based on observing a car having a substantial distance to the robot). Thus, the validation finding 404 may be used to test (i.e., validate) the initial finding.

FIGS. 4 and 5 schematically depict concepts of the detection of passing cars for different scenarios of a traffic environment 1000. The detection of passing cars may also be referred to as passing car detector. In simple terms, a mobile robot 10 may approach a road 20 and may use at least one sensor, such as, for example, cameras, radar, ToF detectors or any a combination of those, to detect any object approaching towards it on a segment of the road, e.g. any approaching cars. For instance, the mobile robot 10 can survey a traffic environment 1000 via the sensors approximately between 0 to 150 meters in both directions, more preferably between 5 to 100 meters in both directions, and most preferably between 10 to 40 meters in both directions.

Afterwards, the surveyed sensor data may be run through algorithms and/or detectors designed to detect faraway moving objects, e.g. faraway driving vehicles, such as cars and/or buses. Multiple sensor data may be combined at this point as well. These processes may be executed directly on the robot and the output can comprise a probability of an approaching object from either direction, e.g. driving car(s) and/or bus(es). Alternatively or additionally, the output may simply comprise a binary result, e.g. YES/NO, indicating the presence or absence of approaching objects. Furthermore, as part of the algorithms and/or detectors, there may be a certain threshold above which it may be considered a detection, and below which may be not. Such an output may comprise a finding (also referred to as hypothesis) on the presence of approaching vehicles on either side of the robot, on the segment of the road accessible to the sensors of the mobile robot 10. In one embodiment, a preferred combination of sensors for far-range object detection may be, for example, cameras and frequency shift keying radar (FSK).

FIG. 4 schematically depicts concepts of the detection of passing cars according to embodiments of the present invention. In FIG. 4A, a mobile robot 10 is approaching a road 20 and may detect a moving object conceptually identified by reference numeral 30. The mobile robot 10 may further identify the object 30 as moving in a direction of the actual or future position of the mobile robot 10. The detection of an object 30 moving in the direction of the mobile robot 10 is performed at a first time, conceptually identified in FIG. 4A by reference numeral t₁. A second measurement at a different time is executed by the sensors of the mobile robot 10, which is schematically depicted in FIG. 4B and conceptually identified by reference numeral t₂. The second time may also be referred to as validation time, as data generated at this time may be used to validate hypotheses created based on data obtained at time t₁. Further, t₂ may also be referred to as observation time t_{obs}. In the sensor data collected in t₂, the object 30 identified in t₁ may effectively be found. Therefore, the mobile robot 10 may record this sequence of identified objects 30 as an event that effectively took place. The time(s), e.g. t₁ and/or t₂, may also be referred to as observation times t₁ and t₂.

In simple words, in FIG. 4A the mobile robot 10 identifies an object 30 that may be considered a vehicle moving towards the position of the mobile robot 10. Subsequently, in FIG. 4B in fact a previously identified object 30 passes in front of the mobile robot 10. In simple words, the at least one sensor inbuilt in the mobile robot 10 may allow the collection of sensor data and after a data processing step may list several potentially detected objects 30, which may also be referred to as detected objects 30. These detected objects 30 may serve as the basis for determining the probability of the correct detection of an object 30. In other words, the detected objects 30 at observation time t_{pbs}=t₂ may provide the input to validate whether an object 30 detected at observation time t₁ is actually a moving vehicle, i.e. if it is actually present in the traffic environment 1000.

If the object 30 detected in t₁ is later present in a second sensor data collected in t₂=t_{obs} (where t₂=t_{obs} is the validation observation time), the mobile robot 10 may record the event as a true occurrence, which may also be referred to as a true positive. In simple words, if an object 30 is detected by the mobile robot in a first sensor measurement, and once again is detected in a second sensor measurement, the mobile robot 10 may confirm that the detected object 30 was in fact present moving towards its positioning. In even more simple words, if an object 30, e.g. a car, passes in front of the mobile robot 10 and this object 30 was previously detected via a sensor, e.g. via a far-range sensor, the far-range detection is considered a true positive detection or simply a true positive.

In FIG. 4C, a mobile robot 10 is approaching a road 20 and may detect a moving object conceptually identified by reference numeral 30. The mobile robot 10 may further identify the object 30 as moving in a direction of the actual or future position of the mobile robot 10. The detection of an object 30 moving in the direction of the mobile robot 10 is performed at an initial time, conceptually identified in FIG. 4C by reference numeral t₁. A second measurement at a different time is executed by the sensors of the mobile robot 10, which is schematically depicted in FIG. 4D and conceptually identified by reference numeral t₂, which may also be referred to as observation time t_{obs}. In the sensor data collected in t₂, the object 30 identified in t₁ may not be found. Therefore, the mobile robot 10 may record this detection sequence of potentially moving objects 30 as an event that has falsely taken place, i.e., the detection with the far-range sensors in FIG. 4C is a false negative detection.

In simple words, in FIG. 4C the mobile robot 10 identifies an object 30 that may be considered a vehicle moving towards the position of the mobile robot 10. Subsequently, in FIG. 4D the previously identified object 30 does not pass in front of the mobile robot 10. In simple words, the at least one sensor inbuilt in the mobile robot 10 may allow the collection of sensor data and after a data processing step may list several potentially detected objects 30, which may also be referred to as detected objects 30. These detected objects 30 may serve as the basis for determining the probability of the correct detection of an object 30. In other words, the potentially detected objects 30 may provide the input to validate whether a potentially detected object 30 is actually a moving vehicle, i.e. if the object 30 is actually present in the traffic environment 1000 and whether the object 30 effectively passes in front of the mobile robot 10.

That is, generally, FIGS. 4A and 4C show the robot 10 measuring some data, and deciding that it detected a car in each case. Sketches 4B and 4D show a different outcome: in the case of 4B, there was actually a car passing in front of the robot 10, and therefore the hypothesis was true (true positive case). In sketch 4D, there was no car passing in front of the robot, and therefore the hypothesis was false (false positive).

If the object 30 detected in t₁ is later not present in a second sensor data collected in t₂=t_{obs}, the mobile robot 10 may record the event as a false occurrence, which may also be referred to as a false positive. In simple words, if an object 30 is detected by the mobile robot in a first sensor measurement but is not detected in a second sensor measurement, the mobile robot 10 may record that the detected object 30 was not moving towards its positioning. In even more simple words, if no object 30, e.g. a car, passes in front of the mobile robot 10 but this object 30 was previously detected via a sensor, e.g. via a far-range sensor, the passing car detection is considered a false positive detection or simply as a false positive.

Consider an exemplary scenario in FIG. 3, which may comprise the detection of a moving object 50 via sensors 200 of the mobile 10 at an observation time t₁. Furthermore, the mobile robot 10 may retrieve further information from the sensor data 202, e.g. that the potentially moving object 50 is moving towards the positioning of the mobile robot 10 at a speed of 40 km/h. Furthermore, the mobile robot 10 may also retrieve information such as estimation of the size of the potentially approaching object 50. The moving object 50 may then continue its journey and may later pass the mobile robot 10. Thus, in a second measurement at an observation time t₂, the moving may be detected, thus resulting in a true positive.

Moreover, the sensors 200 of the mobile robot 10 may also detect, for example, three moving objects of similar size moving towards the mobile robot but still on the opposite side of the road 20, conceptually identified as objects 62, 64 and 66. Furthermore, the mobile robot 10 may detect an additional static object with similar dimensions to that of objects 62, 64 and 66, positioned just in front of the mobile robot 10 and conceptually identified with reference numeral 60. Next to the object 60, the sensors 200 of the mobile 10 may also detect a static longitudinal object conceptually identified with reference numeral 68. The object 68 may further be identified with dimensions such that the mobile robot 10 may label the object 68 as, for example, a traffic light. Additionally, the sensors 200 may also provide information to mobile robot 10 that there are additional potentially moving objects, such as, for example, objects 40 and/or 50, with their corresponding characteristics as mentioned earlier. Such a comprehensive detection of different object in the traffic environment 1000 may represent a simple example of the computer vision of the mobile robot 10.

However, in another scenario, it may be possible that no objects are detected in a first measurement schematically depicted in FIGS. 5A and 5C, and conceptually identified by reference numeral t₁.

In FIG. 5A, a mobile robot 10 is approaching a pedestrian crossing 20 and in a first measurement it may detect no moving objects in the vicinity of the pedestrian crossing 20. Therefore, in a first measurement the mobile robot 10 may recognize the traffic environment 1000 as free of other traffic participants that could potentially intercept its planned trajectory. However, in a second measurement, schematically depicted in FIG. 5B, and conceptually identified by reference numeral t₂, corresponding to validation observation time t_{obs}, the mobile robot 10 may detect a moving object 30. Therefore, the mobile robot 10 may identify that the sensor data collected in t₁ as different from the sensor data collected in t₂, and consequently labelled the event as an incongruent occurrence. It will be understood that the mobile robot 10 may identify an object 30 in a second measurement in a time t₂, and this second measurement may also provide information regarding, for example, to speed and/or direction of the object 30.

In simple words, the at least one sensor inbuilt in the mobile robot 10 may allow the collection of sensor data, which after a data processing step, may permit inferring that the surroundings of current position of the mobile robot 10 is cleared of other traffic participants that may converge with the trajectory of the mobile 10, e.g. moving vehicles. This identified scenario may serve as the basis for determining the probability of the correct detection executed by the mobile robot 10. In other words, the potential scenario assigned as free of moving objects may provide the input to validate whether, for example, the traffic conditions of the road 20 may allow the mobile robot 10 to continue moving without modifying its planned trajectory, e.g. without stopping at the road 20. However, when the sensors of the mobile robot 10, in a second measurement at t₂=t_{obs}, detects a potentially moving object 30, the mobile 10 may confirm that the sensor data collected in t₁ was not containing true information (or was interpreted wrongly), i.e. data collected in a first measurement led to a false negative. In more simple words, if no potentially moving objects 30 are identified in a first sensor measurement, but a moving object 30 passes in front of the mobile robot 10, thus identified by a second sensor measurement, the passing car detection is considered to be a false negative detection or simple as a false negative. In even more simple words, a moving object 30, e.g. a car, passes in front of the mobile robot 10, but it was not previously detected by, for example, a far-range sensor, then the event is recorded as a false negative. It will be understood that no detection of potentially moving objects 30 may also comprise a detection of potentially moving objects 30 but below a minimum certainty threshold.

That is, in the scenario depicted in FIGS. 5A and B, there was no car detected at first observation time t₁, but there is a car detected at validation observation time t_{obs}. In such scenarios, it is possible that at time t₁, there is no car at all detected or that the probability of a car detection is below a threshold at t₁. Generally, at all instances, processed sensor data may be recorded and stored (e.g., they may be recorded to ROS bags) and may then subsequently be analyzed. E.g., it may be analyzed what caused a wrong detection. In some examples, the processed sensor data may also be annotated for further analysis.

Using the previous mentioned example of the false negative detection at time t₁, where the mobile robot 10 is at a pedestrian crossing 20 and an object 50 is on the road 20, it may be possible that the object 50 is a bus parked at a bust stop. Further, it may also be possible that the object 50 is out of the detecting range of the sensors 20. Therefore, it may be possible that in a first measurement at a time t₁ no moving objects are detected. However, the object 50 may start moving and continue its trajectory towards the mobile robot 10 on the road 20, which may result in the detection of a potentially moving object in a second measurement at an observation time t₂. This event may then be labelled by the mobile robot 10 as a false negative, as it presents the characteristics schematically depict in the FIGS. 5A and 5B. It may also be possible that the moving object 50 could not be detected in a first measurement due to a sensor obstructed by other traffic participants, e.g. a pedestrian, and/or due to a malfunction of the sensors of the mobile robot 10.

At a different time, for instance t₂, which may be, e.g. after a couple of seconds, the mobile robot 10 may perform a second measurement using the same combination of sensors (or also different sensors) to collect a second sensor data set. It will be understood that the mobile robot 10 may also use a plurality of different sensors, for example, additional cameras, ultrasonic sensors, etc. I.e., the robot may use the same or other sensors (possibly other cameras, also ultrasonic sensors, radars, ToF or any combination thereof). Such combinations of sensors may be advantageous, as it may allow to increase the precision and recall of the passing car detector.

In the above, it has been described that sensor data based on measurements at an observation time t_{obs}=t₂ may be used by the robot 10 to validate sensor data based on measurements at a first observation time t₁ preceding the observation time. However, it should be understood that this validation step may also be performed “offline”, i.e., not locally on the robot, but on a server to which the sensor data has been uploaded.

That is, in one embodiment, all moving objects, i.e. all passing cars, may be found at all time points for all the mobile robots 10 offline in the servers. Subsequently, it may possible to analyze if every usual car detector detection was true or not. Furthermore, it may be possible to analyze whether a moving object that was detected by some detector, for example, 2 s or 4 s before it actually passed in front of the mobile robot 10 on the traffic road, and is thus detected by the detector at the observation time t₂=t_{obs}.

In some instances, it may possible to determine the time, direction, speed, distance of the moving object, for example, it may be possible to determine that a moving object may be driving at 5 m/s, which may be useful to execute some loose matching, i.e. to estimate if the moving object detected in a first sensor measurement corresponds to the moving object detected in a second sensor measurement.

In some embodiments, it may also be possible to estimate the time to passing in front of the mobile robot 10, i.e. it may be possible to predict the time that a moving object may require to effectively cross in front of the mobile robot 10. It will be understood that this rationale may also be used in reverse. I.e., by determining when an object has passed (by using the validation sensor data), it may be possible to determine when this object should have been detected in a previous measurement. It may also be possible to encounter scenarios where no moving objects were detected in a first sensor measurement, but a moving objected passed in front of the mobile robot 10 a couple of seconds later, thus detected in a second sensor measurement. For these scenarios there may be an additional step and/or process to determine whether the detection was below a threshold to be qualified as such a detection and/or whether there was no detection at all. However, all detection may be recorded, even though no threshold criteria are met. Additionally or alternatively, manual annotations for systems testing, e.g. passing car detectors, may be included.

In FIG. 5C, a mobile robot 10 is approaching a road 20. In a first measurement it may detect no moving objects in the vicinity of the road 20. Therefore, in a first measurement the mobile robot 10 may recognize the traffic environment 1000 as free of other traffic participants that could potentially intercept its planned trajectory. Additionally, in a second measurement, schematically depicted in FIG. 5D, taken at an observation time t_{obs}=t₂, the mobile robot 10 may also detect no moving object 30. Therefore, the mobile robot 10 may identify that the sensor data collected in t₁ correlates with the sensor data collected in t₂, and consequently labelled the event as a real occurrence of no car, i.e., as a true negative.

In simple words, the at least one sensor inbuilt in the mobile robot 10 may allow the collection of initial or raw sensor data, which after a data processing step, may permit inferring that the surroundings of current position of the mobile robot 10 is cleared of other traffic participants that may converge with the trajectory of the mobile 10, e.g. moving vehicles. In other words, the potentially scenario assigned as free of moving objects may provide the input to validate whether, for example, the traffic conditions of roads 20 may allow the mobile robot 10 to continue moving without modifying its planned trajectory, e.g. without stopping at the road 20. Moreover, when the sensors of the mobile 10, in a second measurement at time t₂=t_{obs}, detects no potentially moving object 30, the mobile 10 may confirm that the sensor data collected in t₁ was containing a true information, i.e. data collecting no moving objects 30 are identified in a first sensor measurement (see FIG. 5 C) and no moving object 30 passes in front of the mobile robot 10 (see FIG. 5 D), thus the second sensor measurement also detects no moving objects 30, the passing car detection is considered to be a true negative detection or simply a true negative. In even more simple words, no moving object 30, e.g. a car, passes in front of the mobile robot 10 (and is also not detected at observation time t_{obs}=t₂), and it was also not previously detected by, for example, a far-range sensor, then the event is recorded as a true negative. It will be understood that a no detection of potentially moving objects 30 may also comprise a detection of potentially moving objects 30 but with a minimum certainty threshold.

It will be understood that false negative detections (e.g., a non-detection when there is actually a car approaching—see, e.g., FIGS. 5 A and B) in the above explained scenarios may lead to endangering incidents. E.g., a false negative detection may increase the probability of accidents such as collision of the mobile robot 10 with a moving object 30. Moreover, false positives (e.g., detecting an approaching car when there is actually no car—see, e.g., FIGS. 4 C and D) may lead to lower efficiency and lower average speed of the mobile robot 10, e.g. by causing unnecessary interruptions of the planned trajectory, and/or longer waiting times to cross the road out of overabundance of caution.

It will be understood that technologies to review and validate a hypothesis based on prediction sensor data (i.e., sensor data obtained at the first observation time t₁) are desirable. To do that, in simple words, sensor data obtained at a later stage (i.e., at observation time t_{obs}, also referred to as t₂) may be used. It will be understood that the validation of the hypothesis based on sensors 200 may not be performed in real time on the mobile robot 10. Further, the detector 200 may use future sensor data to validate present sensor data, and/or present sensor data to validate past sensor data. In more simple words, the passing car detector may use second sensor data to validate first sensor data. In other words, the passing car detector may use the data collected in a second sensor measurement to validate the data collected in a first sensor measurement. Moreover, the car passing detectors may be useful for other purposes, such as, for example, testing the quality of far-range car detectors, and/or thresholds for detection of moving objects may be adjusted based on testing done with passing car detector. Further, the present technology can also be used for estimating traffic density.

In some embodiments, the validation of sensor data 202 may also be comprehensive data validation, i.e. other information regarding the detected objects may also be confirmed, such as, for example, a true positive of an event for a moving object with a speed of 40 km/h may be labelled, wherein the speed of the moving objects may also be recorded as a true positive. It will be understood that the comprehensive data validation may be extended to all parameters surveyed from the traffic environment 1000 via the sensors 200, and it will be also understood that the validation may also be performed only for a singular parameter and/or a combination of any survey data, e.g. either only validation of the presence of an detected moving object and/or the validation of a data set containing the presence of a detected moving object, its speed and directions of movement.

FIG. 6 schematically depicts concepts of the validation of detecting cars passing in front of a mobile robot 10. In an initial measurement, the mobile robot 10 may survey a moving object 50, which due to the distance of the moving object to the mobile robot 10 may provide information within the detection limits of the sensors of the mobile robot 10, as schematically represented in FIG. 6A. In the left side of FIG. 6A, a possible image obtained in the situation depicted on the right side of FIG. 6A is depicted. From the right side, it will be understood that an object, e.g., a truck 50 may be approaching far from the left. In an image captured in this situation (see left side of FIG. 6A), the truck 50 may be represented as a small object.

At a later stage, when the truck is passing (see FIG. 6B), the mobile robot 10 may collect a subsequent set of sensor data, which may include the identified object in the proximity of the mobile robot 10, for example, passing in front of the mobile robot 10 as schematically depicted in FIG. 6B. Again, the right side of FIG. 6B depicts the situation encountered by the robot 10 in a top view and the left side of FIG. 6B depicts an image obtained in this situation. It will be understood that in this situation when the truck passes right in front of the robot 10, the truck 50 will be depicted in much greater detail in such in image. In such a measurement, the sensor data may thus provide more accurate information, which may be used to validate the sensor data collected in FIG. 6A. Such an approach may be advantageous, as it may allow to validate sensor data collected by mobile robots 10 and may further facilitate adjusting task operation parameters relating to the safe operation of a mobile robot 10 in a traffic environment 1000, for example, adjusting the sensors' detection limit parameters, which may be decisive in the autonomous operation of the mobile robot 10, for instance, for deciding the next action during operation in a traffic environment 1000, such as, stopping at the road segment 20 and allowing the moving object 50 to pass. In the above, it has mostly been described that the present technology uses sensor data (such as camera data) obtained when a vehicle passes the robot 10 to validate a prior measurement, i.e., a measurement when the vehicle approaches the robot 10. However, it should be understood that this is merely exemplary. Alternatively or additionally, it is also possible that sensor data obtained at a still further time, e.g., when the vehicle has passed, is used to validate the first sensor data. In other words, the present technology can be generally used by using future data for validating present data for the passing car event itself (i.e. the car is visible from the left, front, and right camera).

FIG. 7 depicts a table representing concepts of the validity of detections of two consecutive sensor measurements conceptually identified by reference numeral D1 and D2 for a plurality of mobile robots 10 conceptually identified by R1, R2, R3, R4 and R5, in two different road segment conceptually identified by reference numeral C1 and C2.

Put differently, the different road segments are identified as C1 and C2 and R1 to R5 represent different robots. D1 and D2 represent the results of a measurement based on the first observation time t₁ and the second observation time t₂=t_{obs}. That is, the table of road segment C1 indicate that robots R2 to R5 have detected, e.g., a car in an initial measurement and that this detection was confirmed by the second measurement (all these results are thus true positives). However, robot R1 has not detected a car in the first measurement, but has detected the car in the second measurement (this result thus is a false negative).

That is, the mobile robots 10 (R1-R5) may subsequently survey the same road segments (C1 and C2), however, it may be possible that the data collected by all robots are matching in, for example, detecting a moving object (i.e. a true positive), except for one mobile robot 10, for example, R1, which may be reiteratively miss to identify a moving object in a first measurement D1, i.e. a false negative. Further, a corresponding pattern could also apply in the second road segment. If this type of repetitive events is compared and analyzed using a historical data set, it may allow to identify which mobile robot 10 has sensors not working optimally or with a malfunction. Furthermore, it may also be possible to trace down to individual sensors exhibiting the problem and further may be facilitating adjusting and solving the performance of the sensor. Such an approach may also be advantageous, as it may facilitate maintenance of sensors of mobile robots 10.

That is, the present technology may also allow to detect malfunctioning robots or sensors in robots. It will be understood that false negative detections may be caused by a plurality of circumstances. According to a first example, it may be impossible for a robot to detect an object if a stationary obstacle (such as a tree) is located between the robot and the object, as the obstacle may block the view onto the object. As a second example, weather conditions may lead to false negative results. Consider, e.g., the situation of dense fog. In such a situation it may be impossible for the robot to detect an approaching car at first observation time due to lack of visibility. In a third example, a sensor of a robot may malfunction and thus, it may not be possible to detect a car at a first observation time.

With regard to the above examples, it will be understood that the first two examples (stationary obstacles and low visibility due to fog) may impact different robots in the same way. Thus, in such scenarios, different robots would yield false negative results. However, in the third example (false negative due to malfunctioning detector), only the robot with the malfunctioning detector would yield false negative results. More particularly, this robot would consistently yield false negative results, i.e., not only for one road segment, but for different road segments. This may give rise to results as depicted in FIG. 7. Thus, comparing results for different robots may be used to detect malfunctioning components.

FIG. 8 schematically depicts a method for detecting cars passing in front of a mobile robot 10. In simple terms, the method may comprise a first step conceptually identified by reference numeral S1. The step S1 may comprise measuring first data relating to a road segment via at least one first sensor of a mobile robot at a first observation t₁ to generate a first sensor data 202 containing information regarding a traffic environment 1000.

In a second step conceptually identified by reference numeral S2, the method may comprise, based on the measured first data 202, computing a finding or hypothesis regarding a presence of moving vehicles approaching the mobile robot 10 on the observed stretch of the traffic road, e.g. an object on the road 28. For instance, the mobile robot 10 may determine that the object 50 on the road 28 is moving at 50 km/h towards the road 24. Furthermore, the mobile robot 10 may also consider that the object 50 is of a given size range corresponding to, for example, a bus and/or a truck.

Subsequently, in a third step conceptually identified by reference numeral S3, the method may also comprise measuring second data, i.e., measuring validation data, relating to a road segment via at least one second sensor 200 of a mobile robot 10 at a second observation time t₂ (also referred to as t_{obs} and also referred to as validation observation time), wherein the time t₂ is after time t₁. It will be understood that the second sensor 200 may coincide with the first sensor, or may be different to the first sensor. In this second measurement, the mobile robot 10 may receive information that allows evaluating the hypothesis, such as, for example, a potentially moving object 50 may indeed be detected during the second measuring. Therefore, in a forth step conceptually identified by reference numeral S4, the method may further comprise, based on the measured second data, validating the accuracy of the computed hypothesis. For instance, the mobile robot 10 may record the information from the first measurement, after contrasting with the information contained in a second measurement, as a true positive, i.e. the potentially moving object 50 was in fact, for example, a bus moving towards the mobile robot 10 on the road 24.

Again, with general reference to FIG. 6, it should be understood that different times may be of interest for embodiments of the present technology:

First, at an observation time t₁ (cf. FIG. 6 A), it is desirable that the robot 10 detects the presence of an approaching vehicle 50. At a later validation observation time (which is referred to as t_{obs} or t₂—cf. FIG. 6 B), the vehicle 50 passes and this passing vehicle 50 (e.g., due to the vehicle 50 then being closer to the robot 10) is more reliable detected. This can then be used to validate the detection at time t₁. That is, the detection of a passing vehicle happens in the future (at t₂=t_{obs}) from the actual need of detecting the vehicle by the detector (at t₁).

Second, when detecting the passing vehicle at the observation time t_{obs}=t₂, it should be understood that also sensor data (such as images) obtained at shortly before and after may be used. E.g., when the center of the vehicle 50 is directly in front of the robot at time t₂, also additional sensor data obtained, e.g., less than 1 s before and after this time t₂ may be used to detect the passing vehicle. This may render the detection of the vehicle more reliable. In other words, for the detection of the passing vehicle “future data” from the passing car event can be used, i.e., this step can use data from left and right of the robot 10 which may render this step more reliable makes it lot more reliable.

Third, as discussed before, the calculation to validate the accuracy of the finding based on the data obtained at observation time t₁ (corresponding to FIG. 6 A) does not need to be performed immediately, but can also be performed at a later stage. For example, respective sensor data can be sent to a data processing device that is realized as a server, and the further calculations can be performed on this server. In another alternative, the calculations can also be performed locally on the robot 10, but, e.g., subsequently to the robot 10 crossing the road 20. That is, the calculations can be performed while the robot 10 does not require all of its calculation power to control its operation. Further, as this further analysis is not time critical, also more sophisticated and time consuming operations can be used than would be possible if the results were immediately needed for the operation of the robot 10, thus resulting in more reliable results. In other words, as delay is not important, it also means that a longer time can be used to calculate the passing car detections which means that more powerful algorithms can be employed. Generally, according to the aspect presently described, the calculations may not be performed at the moment, but can be done offline later in a server. Alternatively, they can also be done live in the robot but at a later stage, e.g., after the crossing has finished. This might be advantageous because most (or almost all) of the computing power can then be used for the crossing while the robot crosses the road.

Generally, it will be understood that in embodiments of the present technology, a large amount of data is collected and annotated. This data can be used to determine, for example, how far away vehicles (such as cars) can be seen at different locations on average, e.g., for each crossing, an average distance can be determined at which vehicles can be detected. Further, for some crossings it can be determined that they can be 2D mapped in a better way. E.g., based on the placements and tracks of the detected vehicles, it may be possible amend and fine-tune the information about the topology of roads and crossings i.e. the road map at a given location. Further still, the present technology may allow to determine that in some places occlusions occur more often than in other and the robots could thus avoid them. Also, the performance of different detector properties can be determined with these methods (e.g. a detector setup A can “see” cars at further away distance than detector setup B, but detector setup B can “see” cars with a higher probability at distance 20 m than detector setup A).

Finally, embodiments of the present technology can also be used to set detection thresholds for detection algorithms. That is, the annotated data (where data based on first sensor data is annotated based on validation sensor data) can be used to set thresholds for the detection algorithms transforming the first sensor data to first findings.

While in the above, preferred embodiments have been described with reference to the accompanying drawings, the skilled person will understand that these embodiments were provided for illustrative purpose only and should by no means be construed to limit the scope of the present invention, which is defined by the claims.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method comprising
obtaining validation sensor data from a sensor measurement at a validation observation time;
generating a validation finding based on the validation sensor data;
obtaining first sensor data from a sensor measurement at an observation time preceding the validation observation time;
generating a first finding based on the first sensor data; and
testing the first finding based on the validation finding.

2. The method according to claim 1, wherein the method comprises
a robot driving in an environment, wherein the robot comprises a sensor unit, and wherein the method further comprises
the sensor unit generating initial validation sensor data and initial first sensor data, wherein the validation sensor data is based on the initial validation sensor data and the first sensor data is based on the initial first sensor data.

3. The method according to claim 2, wherein
the validation finding relates to a presence of a vehicle on a road;
the first finding relates to a presence of a vehicle on the road; and
when the initial validation sensor data is generated, the robot is closer to the vehicle than when the initial first sensor data is generated.

4. The method according to claim 3, wherein the method further comprises:
processing the initial validation sensor data to generate the validation sensor data, wherein a quotient between the initial validation sensor data and the validation sensor data is greater than 10, preferably greater than 1,000, further preferably greater than 100,000, such as greater than 1,000,000; and
processing the initial first sensor data to generate the first sensor data, wherein a quotient between the initial first sensor data and the first sensor data is greater than 10, preferably greater than 1,000, further preferably greater than 100,000, such as greater than 1,000,000.

5. The method according to claim 3,
wherein the step of testing the first finding based on the validation finding is triggered when the validation finding indicates that a vehicle is present on the road.

6. The method according to claim 1, wherein the observation time precedes the validation observation time by 1 s to 20 s, preferably by 1 s to 10 s, such as by 1 s to 5 s.

7. The method according to claim 2, wherein the method comprises:
generating a plurality of validation findings; and
generating a plurality of first findings and testing each of the plurality of the first findings based on a validation finding, and thus creating a plurality of test results, wherein the method further comprises utilizing the test results to determine a detection performance of the robot.

8. The method according to claim 7, wherein the method comprises:
a plurality of robots driving in the environment, and wherein
each of the steps is performed for each of the robots to thus determine a detection performance for each of the robots.

9. The method according to claim 8, wherein the method further comprises comparing detection performances of the robots to detect malfunctions.

10. The method according to claim 7, wherein the method further comprises generating a safety score fora road based on the plurality of test results, wherein the safety score is preferably based on a percentage of false negatives within the test results.

11. The method according to claim 1, wherein the method further comprises:
obtaining additional validation sensor data from a sensor measurement at an additional validation observation time,
wherein the validation finding is generated based on the validation sensor data and on the additional validation sensor data.

12. The method according to claim 11, wherein the additional validation observation time is within 2000 ms, preferably 1000 ms, further preferably 500 ms of the validation observation time.

13. The method according to claim 1, wherein the step of testing the first finding based on the validation finding is performed at least 30 s, preferably at least 1 minute, further preferably at least 10 minutes, such as at least 20 minutes, after the validation observation time.

14. A system configured to carry out the method according to claim 1.

15. Use of the system according to claim 14 for carrying out the method according to claim 1.
